(19) United States
(12) Patent Application Publication
(10) Pub. No.: US 2022/0228716 A1
(43) Pub. Date: Jul. 21, 2022

(54) SHAPEABLE STRIP LIGHT

(71) Applicant: ZHONGSHAN HAZEL LIGHT TECHNOLOGY CO., LTD, Zhongshan, Guangdong (CN)

(72) Inventor: Li WANG, Zhongshan (CN)

(73) Assignee: ZHONGSHAN HAZEL LIGHT TECHNOLOGY CO., LTD, Zhongshan, Guangdong (CN)

(21) Appl. No.: 17/278,854

(22) PCT Filed: Nov. 27, 2020
(86) PCT No.: PCT/CN2020/132235

§ 371 Date: Mar. 23, 2021

(30) Foreign Application Priority Data
May 26, 2020 (CN) 202020912530.4

(51) Int. Cl. F21S 4/24; F21V 23/00

(52) U.S. Cl. CPC F21S 4/24; F21Y 2115/10; F21V 23/001

(57) ABSTRACT

A shapeable strip light comprises a light-permeable strip light cover, inside of which being provided with at least an LED light strip and at least a metal strip along the length direction of the strip light cover. Iron wire metal strips are arranged in the light-permeable strip light cover, which improves the shaping ability of the strip light and can maintain the shape for a long time.

### FIELD OF THE INVENTION

The invention relates to a shapeable strip light.

### BACKGROUND OF THE INVENTION

Most of the existing strip lights are flexible strip lights, which are difficult to make shape, and some malleable strip lights are difficult to maintain the shape for a long time and are prone to deformation. At the same time, the existing strip lights are easy to be broken or pulled off when they are bent.

### SUMMARY OF THE INVENTION

The invention overcomes the shortcomings of the above technology and provides a shapeable strip light.

In order to achieve the above purpose, the invention adopts the following technical solutions:

a shapeable strip light, comprising a light-permeable strip light cover, inside of which being provided with at least an LED light strip and at least a metal strip along the length direction of the strip light cover.

In the shapeable strip light, the strip light cover covers the surface of the LED light strip and the metal strip.

In the shapeable strip light, the metal strip is iron wire.

In the shapeable strip light, the metal strip can be multiple.

In the shapeable strip light, the strip light cover is a transparent plastic strip light cover.

In the shapeable strip light, at least a part of an outer surface of the transparent plastic strip light cover is provided with a semi-transparent layer.

In the shapeable strip light, the strip light cover is a cylindrical strip light cover, a square column light cover, or a rounded square column light cover.

In the shapeable strip light, the LED light strip includes two conductive wires, and a plurality of LED lights are connected between the two conductive wires.

In the shapeable strip light, the LED light strip is a flexible strip-shaped LED circuit board.

The beneficial effects of the invention are:

In the invention, iron wire metal strips are arranged in the light-permeable strip light cover, which improves the shaping ability of the strip light and can maintain the shape for a long time. At the same time, the strip light cover completely covers the outer surface of the LED light strip and the iron wire metal strips, and increases the number of iron wire metal strips to further improve the toughness and avoid breaking during the shaping of the strip light. And part of an outer surface of the transparent plastic strip light cover is provided with at least a semi-transparent layer, thereby improving the aesthetics of shape of the light transmission.

### BRIEF DESCRIPTION OF THE DRAWINGS

FIG. 1 is a perspective view of Embodiment 1 of the invention;

FIG. 2 is a perspective view of Embodiment 2 of the invention;

FIG. 3 is a side view of Embodiment 2 of the invention;

FIG. 4 is a perspective view of Embodiment 3 of the invention;

FIG. 5 is a side view of Embodiment 3 of the invention;

FIG. 6 is a star-shaped schematic view of the invention;

FIG. 7 is a 6-shaped schematic view of the invention;

FIG. 8 is a A-shaped schematic view of the invention.

### DETAILED DESCRIPTION OF THE INVENTION

The following is a further detailed description in combination with the drawings and the embodiments of the invention:

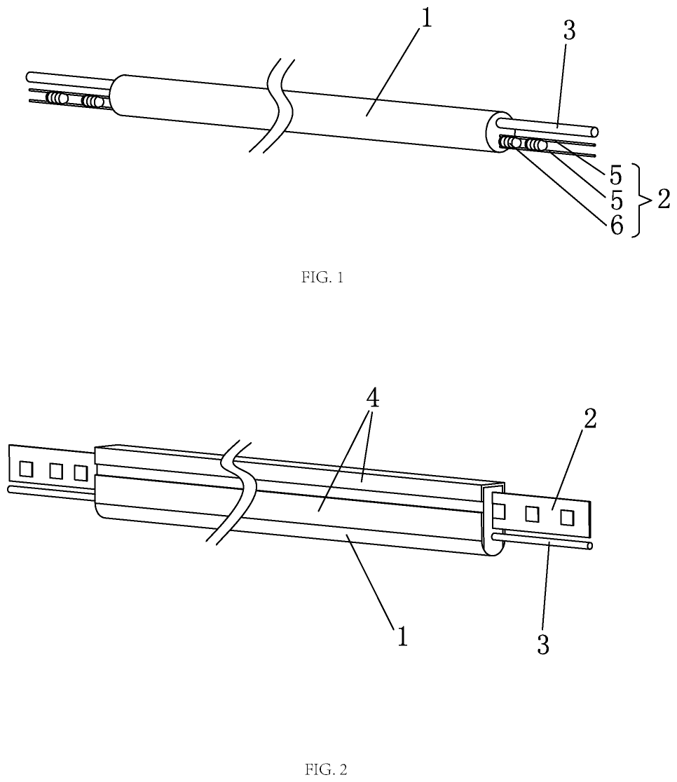

As shown in FIG. 1 to FIG. 5, a shapeable strip light, comprising a light-permeable strip light cover 1, inside of which being provided with at least an LED light strip 2 and at least a metal strip 3 along the length direction of the strip light cover 1. Different shapes can be molded by bending the strip light, such as pentagram shaped, heart-shaped lamp, etc., the metal strip 3 can improve the shaping ability and achieve long-term maintenance of the shape, wherein the strip light cover 1 is a transparent plastic strip light cover, which is easy to process and has high flexibility. The strip light cover 1 covers the surface of the LED light strip 2 and the surface of the metal strip 3, and the metal strip 3 is iron wire, which enhance the toughness of the strip light and play a role in protecting the LED light strip 2, at the same time, the metal strip 3 of the invention can also be copper wire, alloy metal wire, etc., and metal strip of different materials can be selected according to the rigidity and toughness of different needs.

Embodiment 1: As shown in FIG. 1, the strip light cover 1 is a cylindrical strip light cover with an iron wire metal strip embedded in it, and the LED light strip 2 includes two conductive wires 5, and a plurality of LED lights 6 are connected between the two conductive wires 5.

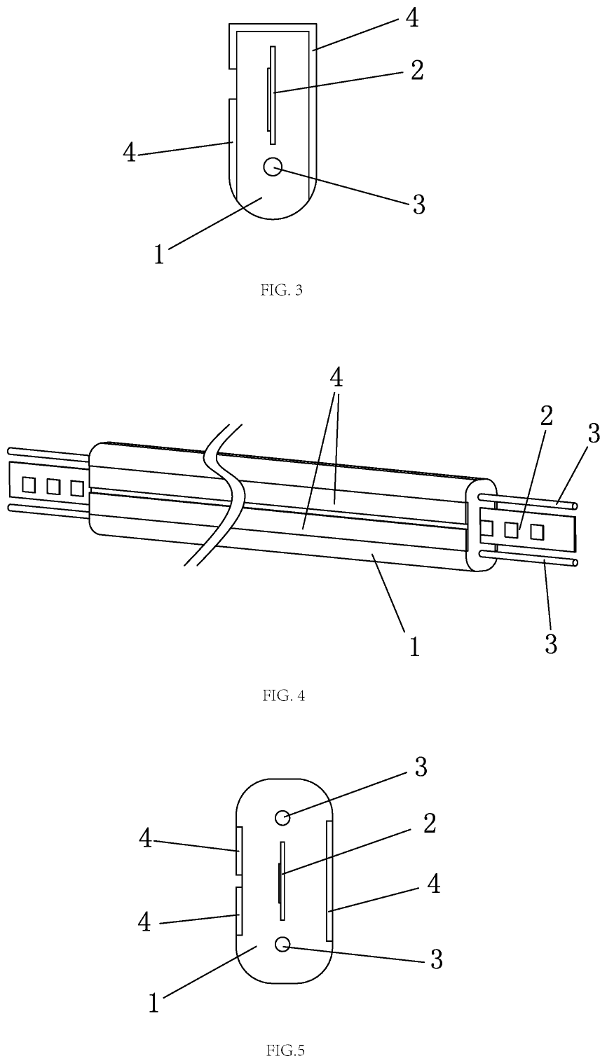

Embodiment 2: As shown in FIG. 2 to FIG. 3, the lower side of the strip light cover 1 is a square column light cover with two rounded corners, and an iron wire metal strip is embedded in it. The LED light strip 2 is a flexible strip-shaped LED circuit board, and parts of outer surface of the transparent plastic strip light cover are provided with semi-transparent layers 4, so that when emitting light, the semi-transparent layers 4 are semi-transparent, and the transparent plastic strip light cover without the semi-transparent layers 4 is fully transparent, which can improve the aesthetics with shaping.

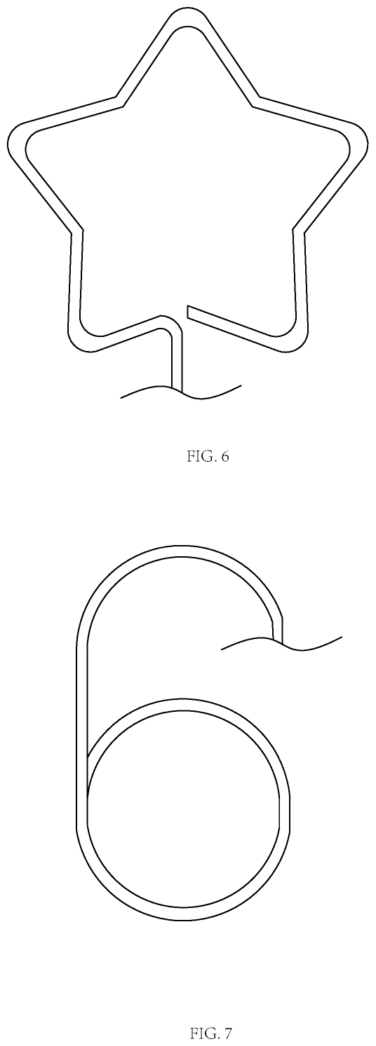

Embodiment 3: As shown in FIG. 4 to FIG. 5, the strip light cover 1 is rounded square column light cover, the LED light strip 2 is a flexible strip-shaped LED circuit board, and both sides of the strip-shaped LED circuit board are respectively provied with an iron wire metal strip by embedding to enhance the toughness, and parts of the outer surface of the transparent plastic strip light cover are respectively provided with a semi-transparent layer 4. So that when emitting light, the semi-transparent layers 4 are semi-transparent, and the transparent plastic strip light cover without the semi-transparent layers 4 is fully transparent, which can improve the aesthetics with shaping.

In the invention, the shape of the strip light cover 1, the number and the light-emitting color of the LED light strip 2, the number and the material of the metal strip, and the area of the strip light cover 1 covered by the semi-transparent layers 4 can be combined according to actual needs, which is not limited to the three embodiments listed in the invention.

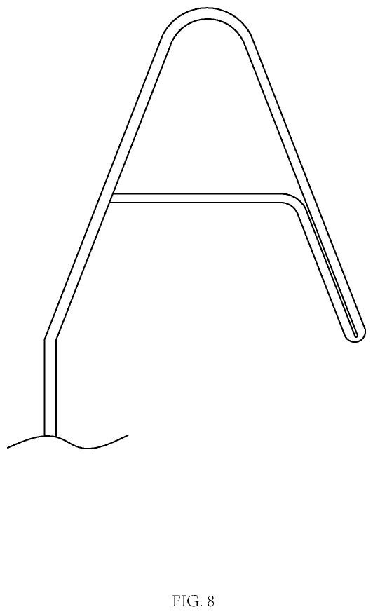

FIG. 6 to FIG. 8 are the schematic views of the bent shape of the strip light of the invention, which are the star-shaped schematic view, the number 6-shaped schematic view and the A-shaped schematic view respectively, at the same time, the strip light of the invention can also be bent into different shapes of lights according to the user's ideas.

1. A shapeable strip light, comprising a light-permeable strip light cover, inside of which being provided with at least an LED light strip and at least a metal strip along the length direction of the strip light cover.

2. The shapeable strip light according to claim 1, wherein the strip light cover covers the surface of the LED light strip and the surface of the metal strip.

3. The shapeable strip light according to claim 1, wherein the metal strip is iron wire.

4. The shapeable strip light according to claim 1, wherein the metal strip can be multiple.

5. The shapeable strip light according to claim 1, wherein the strip light cover is transparent plastic strip light cover.

6. The shapeable strip light according to claim 5, wherein at least a part of an outer surface of the transparent plastic strip light cover is provided with a semi-transparent layer.

7. The shapeable strip light according to claim 1, wherein the strip light covers is a cylindrical strip light cover, a square column light covers, or a rounded square column light cover.

8. The shapeable strip light according to claim 1, wherein the LED light strip includes two conductive wires, and a plurality of LED lights are connected between the two conductive wires.

9. The shapeable strip light according to claim 1, wherein the LED light strip is a flexible strip-shaped LED circuit board.

10. The shapeable strip light according to claim 2, wherein the metal strip is iron wire.

11. The shapeable strip light according to claim 2, wherein the metal strip can be multiple.

12. The shapeable strip light according to claim 2, wherein the strip light cover is transparent plastic strip light cover.

13. The shapeable strip light according to claim 12, wherein at least a part of an outer surface of the transparent plastic strip light cover is provided with a semi-transparent layer.

14. The shapeable strip light according to claim 2, wherein the strip light covers is a cylindrical strip light cover, a square column light covers, or a rounded square column light cover.

15. The shapeable strip light according to claim 2, wherein the LED light strip includes two conductive wires, and a plurality of LED lights are connected between the two conductive wires.

16. The shapeable strip light according to claim 2, wherein the LED light strip is a flexible strip-shaped LED circuit board.
